(19) United States
(12) Patent Application Publication
(10) Pub. No.: US 2009/0182635 A1
(43) Pub. Date: Jul. 16, 2009

(54) Vehicle Inspection System and Process

(76) Inventors: Robert F. Parisi, Blue Point, NY (US); Robert A. Masi, Garden City Park, NY (US)

Correspondence Address: HARVEY LUNENFELD, 8 Patrician Drive, East Northport, NY, 11731, US

(21) Appl. No.: 12/354,763

(22) Filed: Jan. 15, 2009

Related U.S. Application Data
(60) Provisional application No. 61/021,034, filed on Jan. 15, 2008.

(51) Int. Cl. G06Q 99/00

(52) U.S. Cl. 705/14; 705/1

(57) ABSTRACT

An inspection system and process that allows requesters to electronically request inspections to be made of one or more items and/or properties at one or more remote locations, for the request to be electronically routed via a processor to one or more electronic devices to be carried and used by inspectors to receive such requests wirelessly and to be used at the remote locations for collecting data, entering inspection information, and observations on site into the electronic devices, wirelessly sending inspection results back to the processor, for the processor to process the observations, inspection information, and/or data into condition reports, incorporate advertisements into the condition reports and electronically send the condition reports to the requestors and/or owners of the items and/or property. The advertisements may include video, audio, and/or text components and be directed to demographics associated with the requesters and/or the owners of the items and/or property being inspected.

This application claims the benefit of U.S. Provisional Application No. 61/021,034, filed Jan. 15, 2008, the full disclosure of which is incorporated herein by reference. The present application is also related to Canadian Patent Application No. 2,618,739, filed Jan. 15, 2008. The above referenced documents are not admitted to be prior art with respect to the present invention by their mention herein.

### BACKGROUND OF THE INVENTION

1. Field of the Invention

The present invention relates generally to inspection systems and more particularly to vehicle inspection that communicate inspection results electronically.

2. Background Art

Vehicle and other inspections typically occur at the end of a lease and/or prior to sale and/or purchase of high value items or property, such as, for example, automobiles, planes, boats, antiques, paintings, and/or artwork. In such instances, the inspector receives a request, from and individual and/or institution, to inspect an item or items of interest, travels to an appropriate location or locations, where the item or items can be inspected, views and/or manually performs tests on the item or items of interest, and sends a report to the requester and/or owner of the item or items of interest. Inspection requests are often made via mail, phone, or fax, and the results are typically sent to the requester and/or the owner of the items or property via mail, phone, or fax.

There is a need for an inspection system and process that allows requestors to electronically request one or more inspections to be made on one or more items and/or property at a particular location or locations, for the request to be electronically routed via a processor to one or more electronic devices to be carried and used by inspectors to receive such information wirelessly and to be used at inspection site locations for collecting data, entering observations and inspection information and/or data on site into the electronic devices, wirelessly sending inspection results back to the processor, and for the processor to electronically send the inspection results to the requestors and/or owners of the items and/or property. The inspection system and process should also be capable of incorporating advertisements into each of the inspection results to be sent to the owners of the items and/or property and/or into the inspection results to be sent to the requesters. The advertisements may include video, audio, and/or text components and be directed to demographics associated with the requestors and/or the owners of the items and/or property being inspected. The inspection system and/or process should be capable of being used for items and/or property of virtually any kind, and in particular high value items or property, such as, for example, automobiles, planes, boats, antiques, paintings, and/or artwork.

### SUMMARY

The present invention is directed to an inspection system and process that allows requesters to electronically request one or more inspections to be made on one or more items and/or property at a particular location or locations, for the request to be electronically routed via a processor to one or more electronic devices to be carried and used by inspectors to receive such information wirelessly and to be used at inspection site locations for collecting data, entering observations and inspection information and/or data on site into the electronic devices, wirelessly sending inspection results back to the processor, and for the processor to electronically send the inspection results to the requesters and/or owners of the items and/or property. The inspection system and process are capable of incorporating advertisements into each of the inspection results to be sent to the owners of the items and/or property and/or into the inspection results to be sent to the requesters. The advertisements may include video, audio, and/or text components and be directed to demographics associated with the requestors and/or the owners of the items and/or property being inspected. The inspection system and/or process may be used for items and/or property of virtually any kind, and in particular high value items or property, such as, for example, automobiles, planes, boats, antiques, paintings, and/or artwork.

A vehicle inspection process executing on a hardware device comprising an inspection tracking and management system having features of the present invention comprises, comprises: (a) receiving, at the inspection tracking and management system, a first request electronically from a requesting entity for an inspector to perform an inspection of a vehicle at a remote location, the first request comprising information identifying the vehicle, the remote location, and vehicle owner; (b) selecting, by the inspection tracking and management system, the inspector from a plurality of available inspectors; (c) sending, by the inspection tracking and management system, a second request electronically to the selected inspector for the selected inspector to perform the inspection of the vehicle at the remote location; (d) receiving, by the inspection tracking and management system, an inspection report electronically from the selected inspector comprising information about the condition of the vehicle; (e) processing, by the inspection tracking and management system, the inspection report into a condition report, comprising the information about the condition of the vehicle; (f) sending, by the inspection tracking and management system, to the vehicle owner and the requesting entity, information for accessing the condition report within the inspection tracking and management system; (g) receiving, at the inspection tracking and management system, from the vehicle owner and/or the requesting entity, a third request for accessing the condition report within the inspection tracking and management system; (h) allowing, by the inspection tracking and management system, by the vehicle owner and/or the requesting entity, access to the condition report within the inspection tracking and management system for the vehicle owner and/or the requesting entity to review the condition report.

### DRAWINGS

These and other features, aspects, and advantages of the present invention will become better understood with regard to the following description, appended claims, and accompanying drawings where:

FIG. 1 is a schematic representation of a vehicle inspection system, constructed in accordance with the present invention;

FIG. 2 is a schematic representation of steps of a vehicle inspection process of the present invention;

FIG. 3 is a schematic representation of steps of a process of authenticating requests at the tracking and management system of the vehicle inspection process of FIG. 2;

FIG. 4 is a schematic representation of steps of a process of validating the requests at the tracking and management system of the vehicle inspection process of FIG. 2;

FIG. 5 is a schematic representation of steps of a process of preprocessing the requests at the tracking and management system of the vehicle inspection process of FIG. 2;

FIG. 6 is a schematic representation of steps of a process of processing the requests at the tracking and management system of the vehicle inspection process of FIG. 2 into preliminary inspector assignments;

FIG. 7 is a schematic representation of steps of a process of processing the requests at the tracking and management system of the vehicle inspection process of FIG. 2 by grouping and/or sorting the requests;

FIG. 8 is a schematic representation of steps of a process of processing the requests at the tracking and management system of the vehicle inspection process of FIG. 2 into appointments;

FIG. 9 is a schematic representation of steps of a process of processing the requests at the tracking and management system of the vehicle inspection process of FIG. 2 into geographical locations;

FIG. 10 is a schematic representation of steps of a process of processing the requests at the tracking and management system of the vehicle inspection process of FIG. 2 by confirming customer availability, location, and inspector assignment;

FIG. 11 is a schematic representation of steps of a process of finalizing inspector assignments at the tracking and management system of the vehicle inspection process of FIG. 2 and sending the finalized inspector requests to the inspectors;

FIG. 12 is a schematic representation of steps of a process of preliminary data collection in preparation for inspecting vehicles and collecting on site data of the vehicle inspection process of FIG. 2;

FIG. 13 is a schematic representation of steps of a process of on site visual and photographic data collection of the vehicle inspection process of FIG. 2;

FIG. 14 is a schematic representation of steps of a portion of the process of on site visual and photographic data collection process of FIG. 13;

FIG. 15 is a schematic representation of steps of another portion of the process of on site visual and photographic data collection process of FIG. 13;

FIG. 16 is a schematic representation of steps of a process of sending collected inspections data to the tracking and management system of the vehicle inspection process of FIG. 2;

FIG. 17 is a schematic representation of steps of a process of post processing inspection results into inspection reports at the tracking and management system of the vehicle inspection process of FIG. 2;

FIG. 18 is a schematic representation of steps of a process of sending the inspection reports from the tracking and management system of the vehicle inspection process of FIG. 2 to customers and/or property owners;

FIG. 19 is a schematic representation of steps of a process of creating and sending bills and/or inspection reports of the vehicle inspection process of FIG. 2 to the customers and/or the property owners;

FIG. 20 is a schematic representation of one of the inspection reports;

FIG. 21 is a schematic representation of a graphical user interface of the present invention for collecting data;

FIG. 22 is schematic representation of a signature capture graphical user interface of the present invention;

FIG. 23 is a schematic representation of steps of a synchronization process of the vehicle inspection process of FIG. 2 at the tracking and management system;

FIG. 24 is a schematic representation of an inspection mobile device data synchronization graphical user interface;

FIG. 25 is another schematic representation of the vehicle inspection system of FIG. 1, showing the vehicle inspection system in more detail; and

FIG. 26 is a schematic representation of steps of process for an inspection report showing an advertisement that may be based upon demographic information presented to the customer and/or property owner; and

FIG. 27 is a schematic representation of a graphical user interface of a condition report main page of the vehicle inspection system, showing a vehicle condition report and the advertisement.

### DESCRIPTION

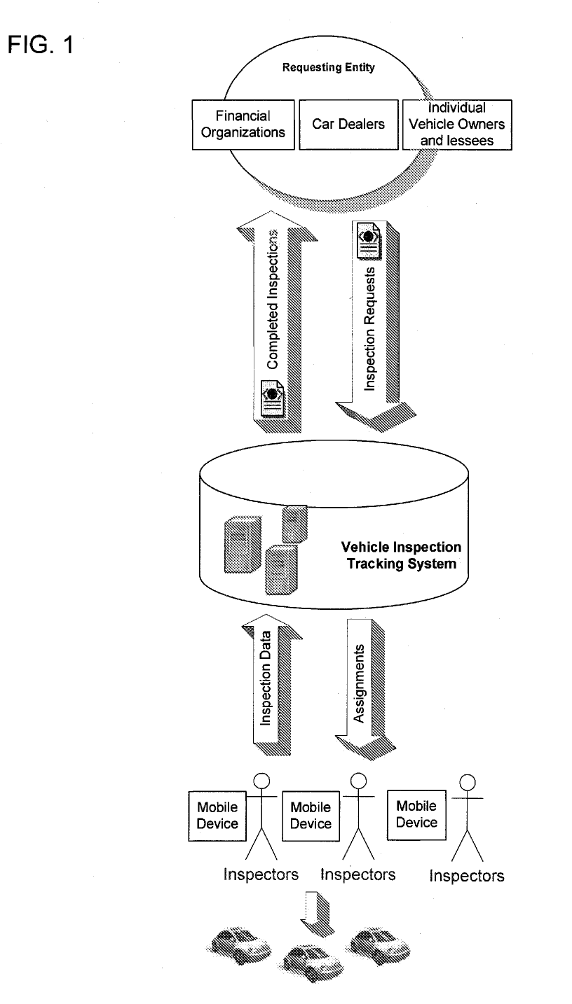

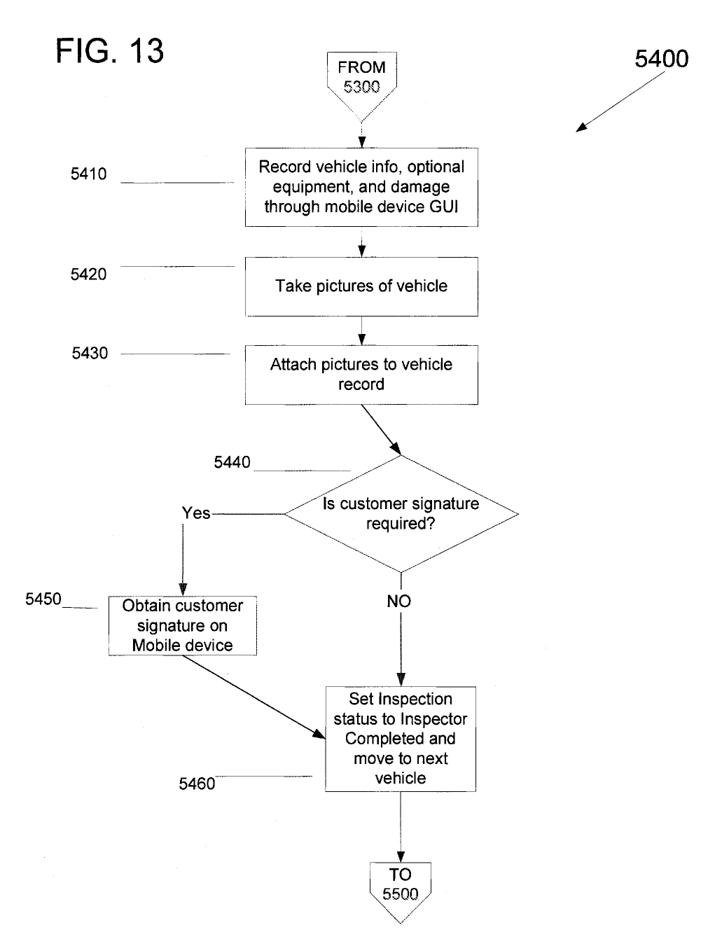

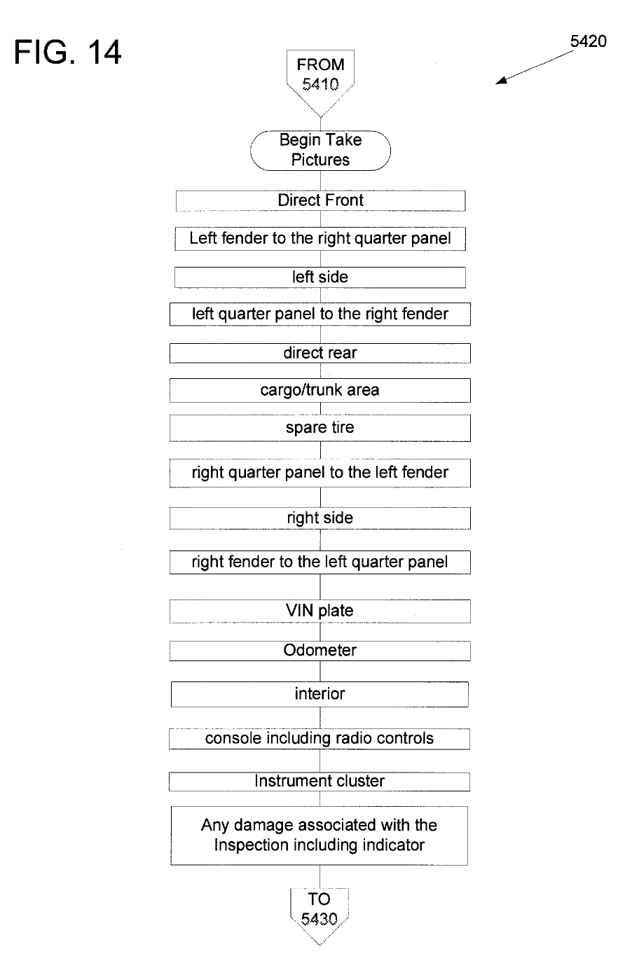

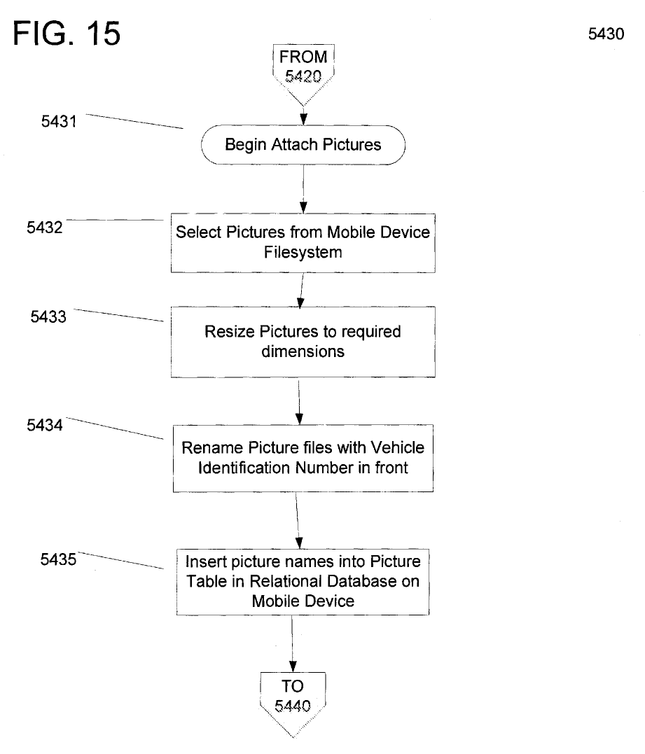

The preferred embodiments of the present invention will be described with reference to FIGS. 1-27 of the drawings. Identical elements in the various figures are identified with the same reference numbers.

The present invention provides a method and system for accepting, processing, and completing a vehicle inspection request and delivering a vehicle condition report to a requesting entity and or designated recipients combined with targeted advertising based on elements present in the vehicle condition report. In addition, the present invention provides a system for billing and tracking payment for completed inspection requests.

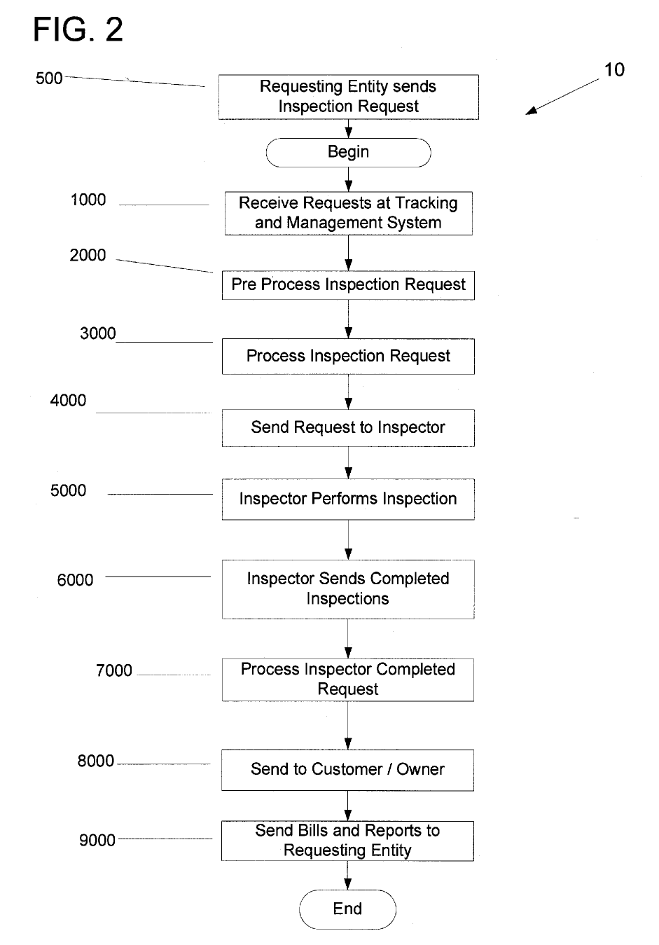

FIG. 2 is a flow chart of the processing steps of the present invention. The requesting entity begins the process 500 by sending an inspection request to an Inspection Tracking and Management System. The request may be sent via email, Simple Object Access Protocol (SOAP), a web site, postal mail or by telephone, and/or other alternative forms. The Inspection Tracking and Management System receives the Inspection Request 1000 according to the sending method. Pre-processing 2000 is then performed to incorporate the Inspection Request into the Tracking and Management system. The Inspection request is then processed 3000 in order to assign an Inspector to perform the inspection and coordinate and or confirm the inspection place and time if necessary. The Inspection Request is then sent 4000 to the Inspector. The Inspection Request may be sent to the Inspector via email, Simple Object Access Protocol (SOAP), a web site, postal mail or by telephone, and/or other alternative forms. In one embodiment of the present invention, the Inspection Request is sent via a specifically built mobile inspection device that is designed to communicate with the Inspection Tracking and Management System. The Inspector then inspects the vehicle 5000 and records the vehicle condition information according to pre-determined specifications.

In one embodiment of the present invention, the mobile inspection device presents a graphical user interface to the inspector to walk through recording the vehicle condition information necessary to complete the inspection process. The inspector then sends 6000 the completed inspection information back to the Inspection Tracking and Management System. The completed Inspection information may be sent to the Inspection Tracking and Management System via email, Simple Object Access Protocol (SOAP), a web site, postal mail or by telephone, and/or other alternative forms. In one embodiment of the present invention, the Inspection information is sent the mobile inspection device using SOAP and Secure Sockets Layer. The Inspection Tracking and Management System then begins post process 7000 functions to quality control the inspection data that was sent and ensure completeness. The Inspection Tracking and Management System then sends a Condition Report 8000 containing the completed Inspection information to the Requesting Entity and or other Designated Recipients. The condition report may be delivered in a variety of ways including but not limited to email, Simple Object Access Protocol (SOAP), a web site, postal mail or by telephone using a text to speech engine or other agent, and/or other alternative forms. The Inspection Tracking and Management System then begins the billing process 9000 and tracks payment of individual inspection requests.

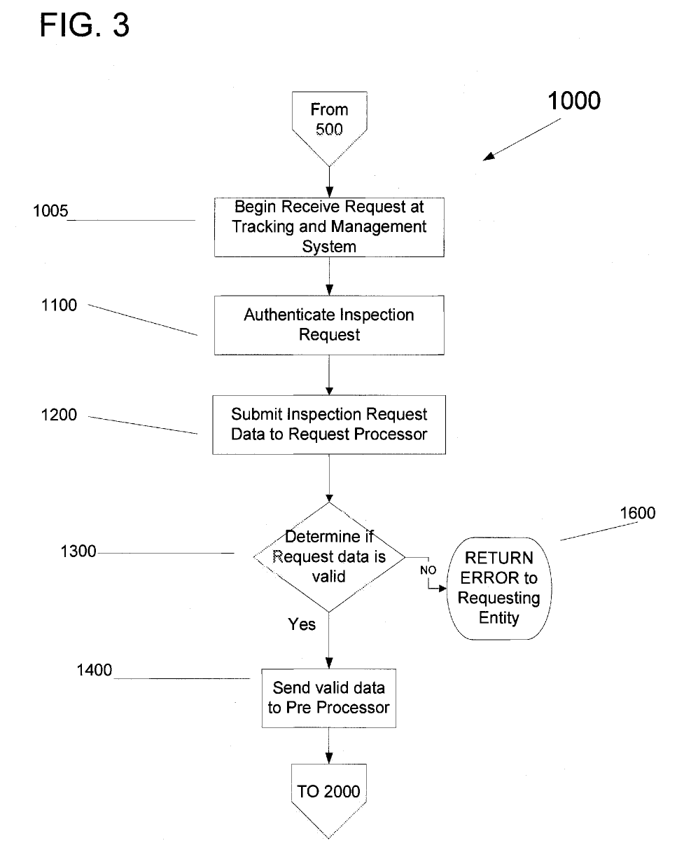

FIG. 3 is a flow chart of the process of receiving inspection requests of the present invention. In step 1005 the Inspection Tracking and Management System begins the process of receiving requests by accepting a communication attempt by a Requesting Entity. The Inspection Tracking and Management System will be able to accept requests using many different requests and many different communication protocols at once. In one example, a SOAP request is initiated by a requesting entity and a SOAP based Web service that is part of the Tracking and Management System accepts the request. The Request must then be authenticated 1100 to determine the identity of the Requesting entity. The Inspection Tracking and Management System stores identity information for known Requesting Entities in a data store and searches the data store for the presence of the set of credentials sent by the requesting entity to confirm the identity of the Requesting Entity. The identity information may be stored in a variety of information storage mediums including but not limited to an LDAP database, relational database, encrypted file system or a combination thereof, and/or other alternative forms.

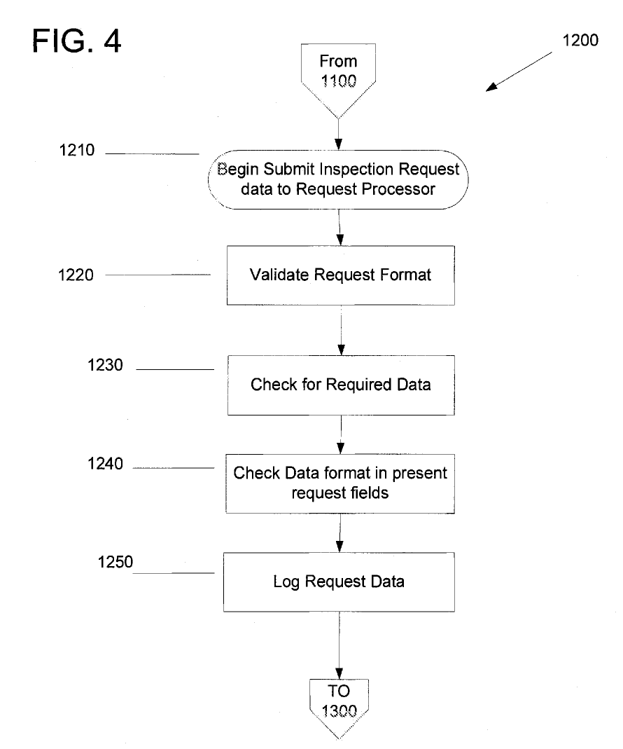

In step 1200, the request data is then submitted to a Request Processor. FIG. 4 is a flow chart of the process of submitting an Inspection Request to the Request Processor component of the present invention. The request processor must first validate the request format 1220. In one example, the request is sent via a SOAP based Web service containing request data stored in Extensible Markup Language (XML) format. The request processor must first validate proper XML formatting in order to continue. In the next step 1230, the request processor checks for the presence of all data that is required in order to accept an inspection request from the requesting entity making the current request. In one example, the Inspection Tracking and Management System requires all requests from one particular requesting entity to contain Vehicle Identification Number, Year, Make, Model and color. In another example, the Inspection Tracking and Management System requires all requests to contain Vehicle Owner information as well. The next step 1240 is to check the data format of each item of information provided in the inspection whether required or optional. In one example, the request processor validates that the information given for YEAR of manufacture is in fact a valid year and conforms to the requirements of the Inspection Tracking and Management System's data store. The request processor then logs 1250 the Inspection request data for verification and debugging purposes. Logging data may be accomplished by alternative means, including but not limited to written into one or more text files and stored in a file system, written into a relational or object database or sent over a communication network to a logging server like UNIX syslog or windows event tracker.

If the Request processor determines that the request data is valid 1300 then the data is sent 1400 to the pre process functions of the Tracking and Management System; otherwise, an error condition is communicated back to the Requesting Entity 1600 and the request process must be started again.

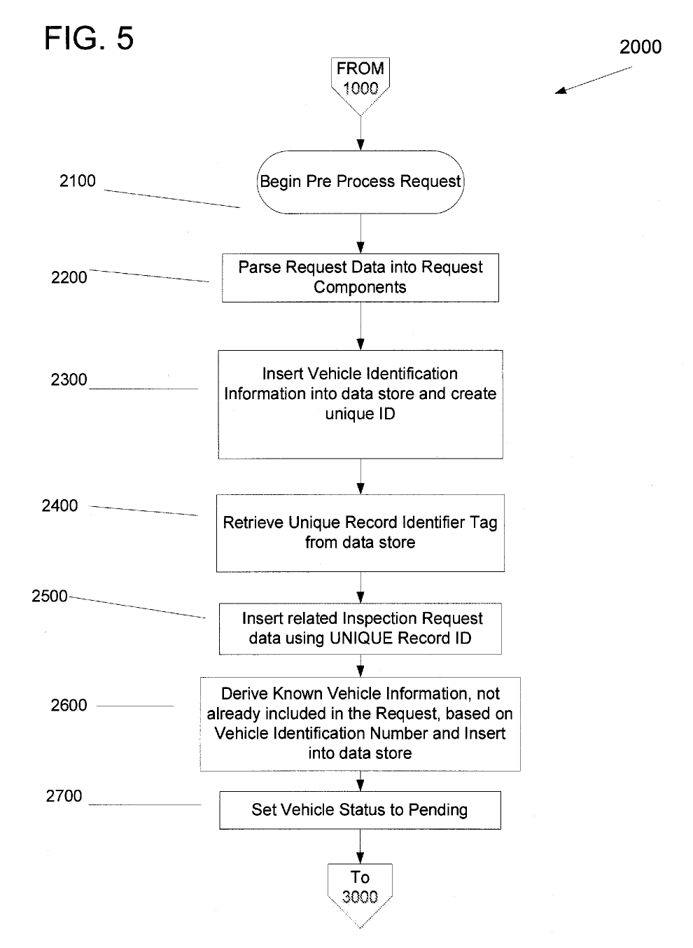

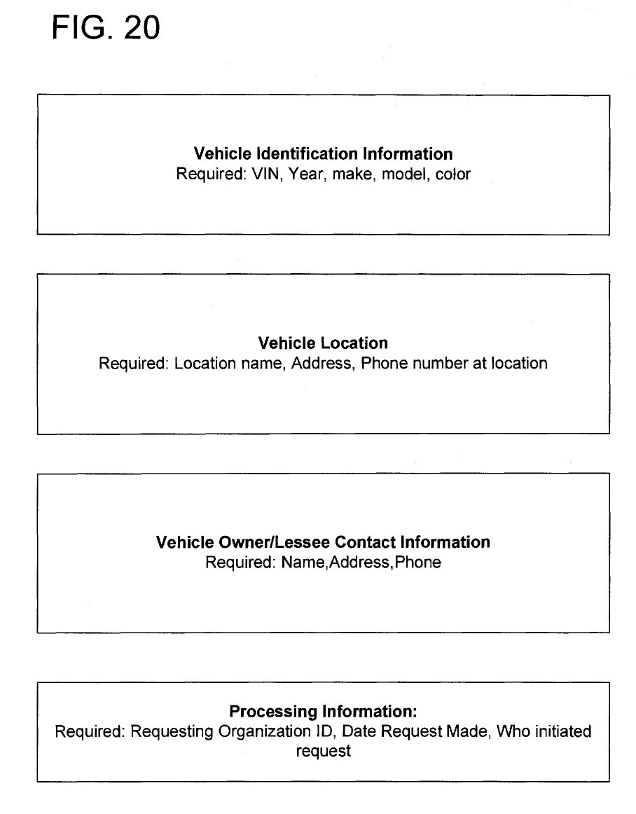

FIG. 5 is a flow chart of the Inspection Request Pre Processing functions of the present invention. The Pre processing functions begin 2100 by accepting validated request data from the request processor. Communication may be facilitated by, for example, SOAP Web services, Remote Method Invocation (RMI), Remote Procedure Call, Local method call or object instantiation and operating system shell commands, and/or other alternative forms. In step 2200, the pre processor parses the request data into individual request components. FIG. 20 is a block diagram of the Individual Request Components. Vehicle Identification Information is then inserted 2300 into the Inspection Tracking and Management System data store. In step, 2400 a UNIQUE record identifier tag associated with the previously inserted Vehicle Identification information is retrieved from the data store. The other related inspection request data is then added to the data store using the unique record identifier tag 2500. The next step 2600 is to use the Vehicle Identification Number to derive any other information that may possibly be derived related to the vehicle referenced in the Inspection request and incorporate that information into the data store. In one embodiment of the invention a VIN decoder is used to derive optional equipment and interior and exterior color. The next step 2700 is to store the vehicle status in the data store as PENDING so other agents may observe that the inspection request is ready for processing.

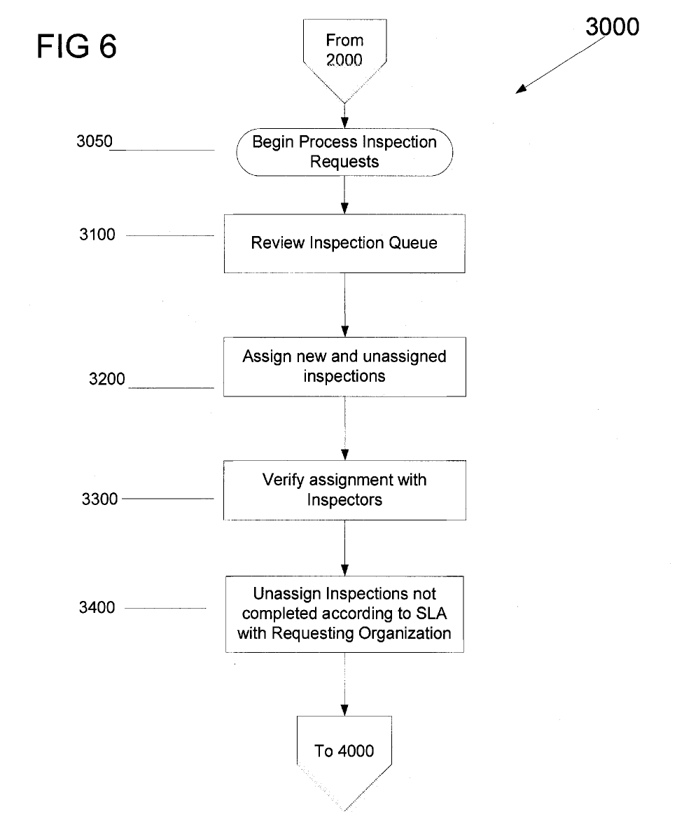

FIG. 6 is a flow chart of the Inspection Request Processing functions of the present invention. A processing agent begins 3050 this process by accessing the Inspection Tracking and Management System. The agent is authenticated and identified for auditing, performance management and other purposes and reviews an Inspection Queue 3100 to identify inspection requests in need of processing. The next step 3200 is to assign new and other unassigned inspection requests to an inspector. After assignment, the agent must verify the assignment with the inspector 3300. In the next step 3400, the agent un-assigns currently assigned inspections that have not been completed by an inspection completion deadline.

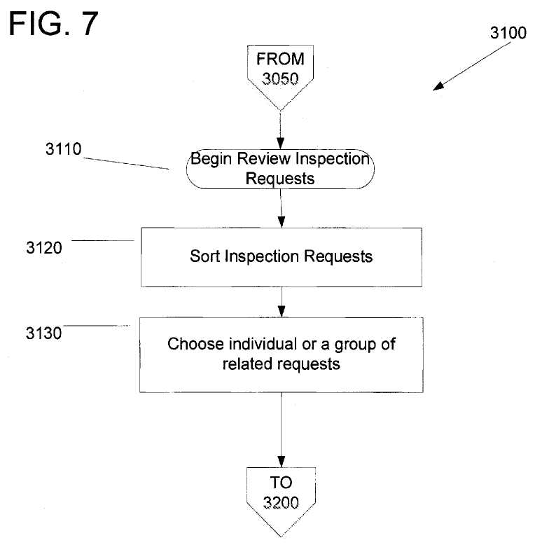

FIG. 7 is a flow chart of the Inspection Request Review process of the present invention. The inspection queue is sorted 3120 to identify groups of potentially related inspection requests and one or more are selected for assignment 3130. In one embodiment of the present invention, the inspection queue is sorted by vehicle location to find inspection requests geographically located near each other.

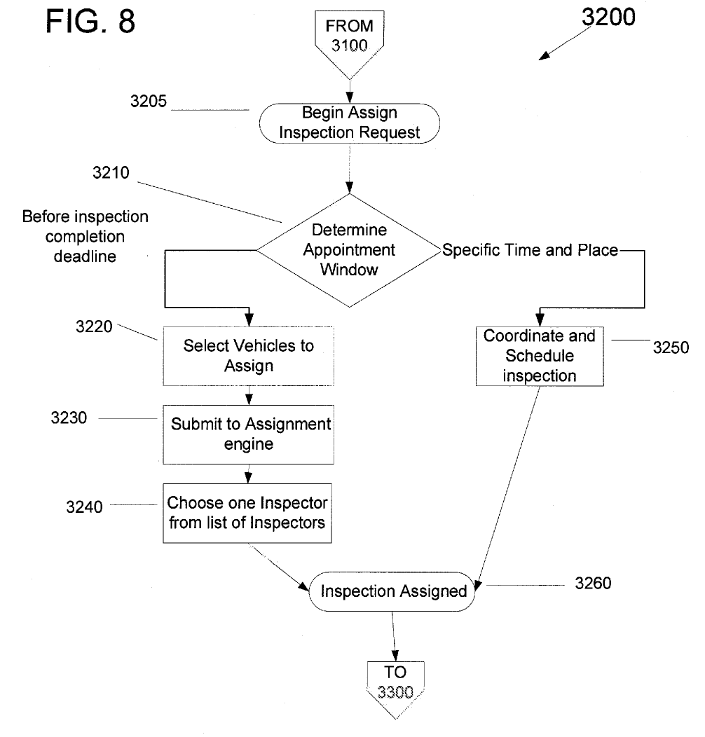

FIG. 8 is a flow chart of the Assign Inspection Request function of the present invention. Inspection Requests may require a specific time and place for the inspection to occur or may only require that the inspection be completed by the inspection completion deadline. The agent determines the Appointment window 3210 for an individual or group of inspection requests. If the appointment window is a specific time and place then the agent must begin the coordinate and schedule inspection process 3250. If the appointment window is determined to be anytime before the inspection completion deadline then the agent selects one or more inspection requests 3220 and submits the selected inspection requests to an assignment engine 3230. The assignment engine then returns a list of available inspectors and the agent chooses one to assign 3240.

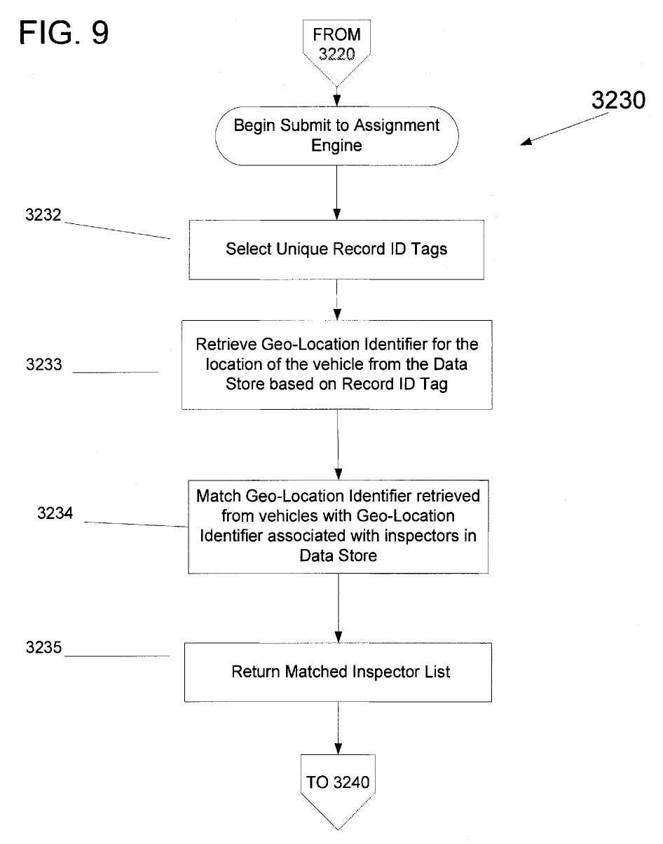

FIG. 9 is a flow chart of the Submit to Assignment Engine function of the present invention. One or more inspection requests are sent to the assignment. The assignment engine selects the unique record identifier tags associated with each vehicle request 3232. The assignment engine then retrieves the geographic location identifier for the location of the vehicle 3233. The geographic location identifier may consist of any item of information useful for establishing a geographic location including but not limited to area code, postal address, grid coordinates, longitude and latitude, or combination thereof. The geographic location identifier associated with the inspection requests is then matched 3234 against the geographic location identifier associated with the inspectors present in the data store. The list of matched inspectors is then returned 3235.

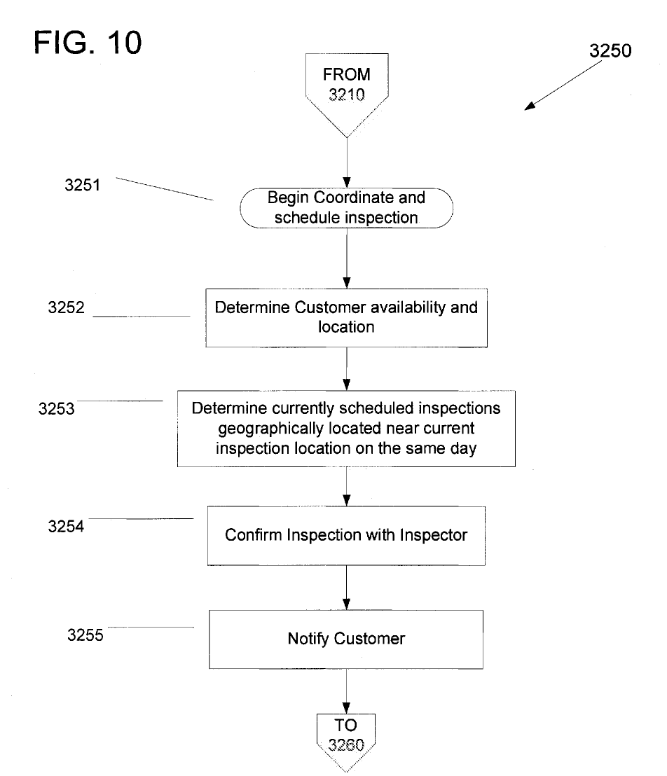

FIG. 10 is a flow chart of the Coordinate and Schedule Inspection function of the present invention. The first step is to determine Customer availability and location 3252. The next step 3253 is to find the currently scheduled inspections geographically located near the current inspection request on the same day in order to make efficient use of the inspectors time. The next step 3254 is to confirm the inspection schedule with the inspector. The next step 3255 is to notify the customer that the inspection is scheduled. This notification may be accomplished in a variety of ways, including but not limited to email, telephone, postal mail or combination thereof.

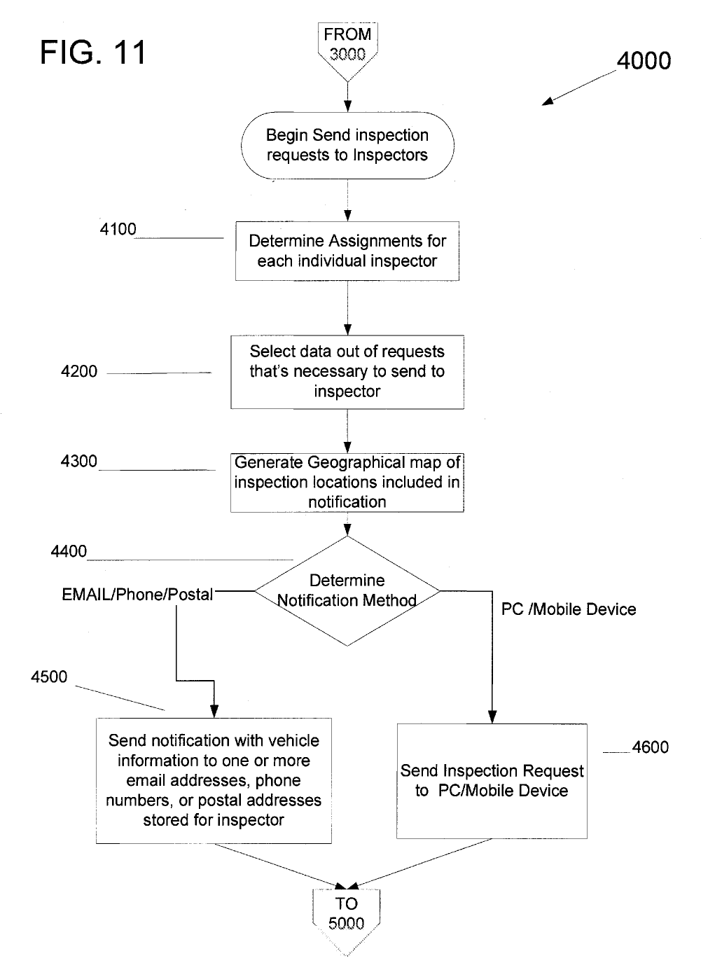

FIG. 11 is a flow chart of the Send Inspection Requests to Inspector function of the present invention. The Inspection Tracking and Management System determines the assigned inspections for each individual inspector 4100. This may be performed at the request of an inspector or at the request of an agent interfacing with the Tracking and Management System during the assignment process or on a scheduled basis. Only the data that is necessary to perform the inspections 4200 is selected out of the data store. A geographical map 4300 that may or may not contain driving directions and/or suggested route is then produced containing the inspection locations included in the current notification. The notification method is then determined 4400. If the method is determined to be email, phone, or postal address the Vehicle information is sent 4500 to one or more addresses stored for the individual inspector. If the method is determined to be PC/Mobile device the Inspection Tracking and Management System sends 4600 the inspection request data to the Mobile Inspection Device.

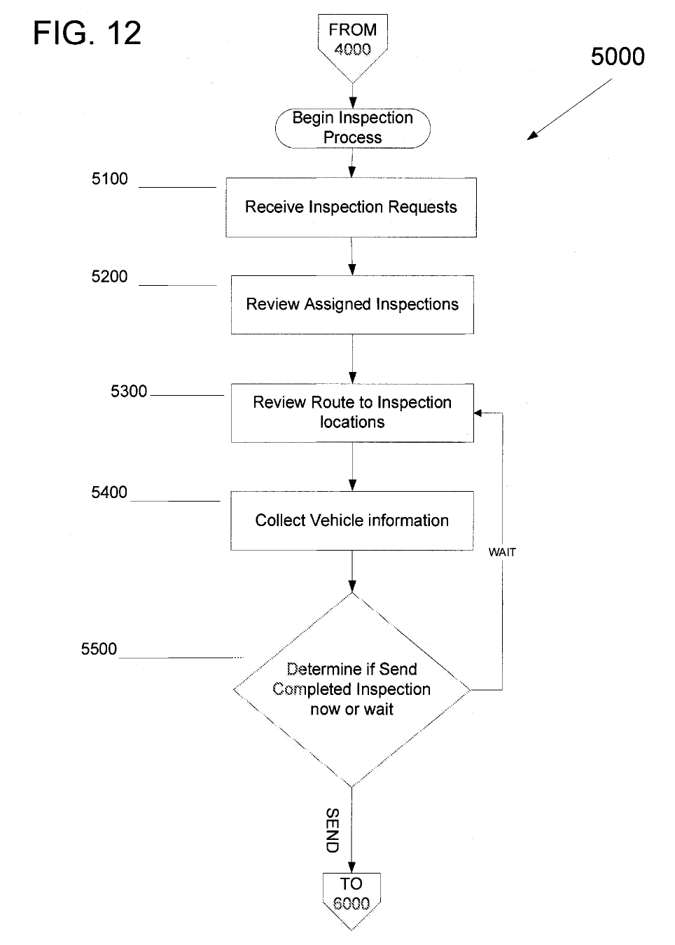

FIG. 12 is a flow chart of steps in a process of performing a vehicle inspection in the present invention. Inspection requests are received 5100 by an inspector. The inspector then reviews the assigned inspections 5200. The inspector next reviews the route to the inspection locations 5300 and travels to the first location to perform the inspection. The inspector next collects the required vehicle information at the inspection location 5400. The inspector then determines 5500 if the completed inspection data will be sent immediately or if the inspector will move on to the next inspection.

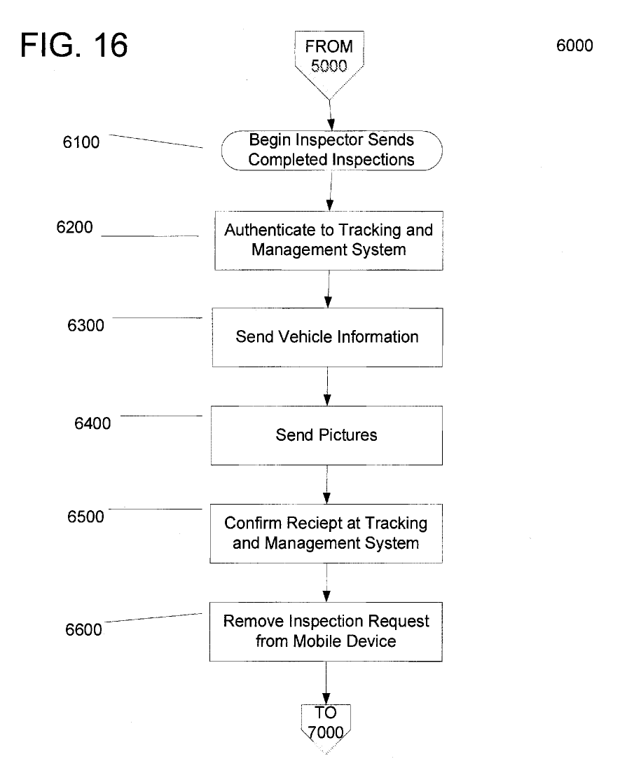

FIG. 16 is a flow chart of the process of sending completed inspection data to the Inspection Tracking and Management System of the present invention. The Inspector begins the process 6100 by running an Inspection Data Synchronization program on the Mobile Inspection Device. The Synchronization Program first reads a configuration file and checks for connectivity to the Inspection Tracking and Management System. The synchronization program then authenticates to the Inspection Tracking and Management System 6200. In the next step 6300, the vehicle information is sent and then the pictures associated with each inspection 6400. Once receipt of all information is confirmed by the Inspection Tracking and Management System 6500, the completed inspection is removed from the Mobile Inspection Device data store 6600.

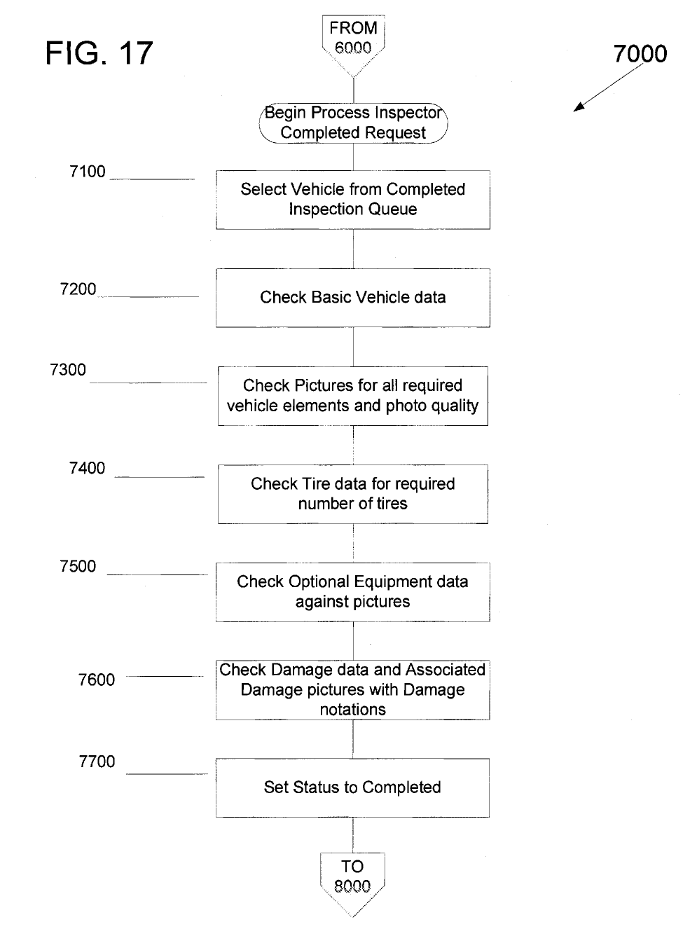

FIG. 17 is a flow chart of the Post Process Request function of the present invention. A Management agent quality checks all inspection requests completed by the inspectors. Completed Inspection requests are chosen 7100 in an order chosen by the Management Agent. In one example, the management agent chooses completed inspection requests in order of Request date. All Inspection Request components are checked for accuracy and completeness. The management agent first checks all basic vehicle data that is required is present 7200. In the next step 7300 the Management agent checks for all required pictures, verifies picture naming rules are followed and picture quality is acceptable. In the next step 7400, the Management Agent verifies that all required tire information is present. In one example the agent checks that tread depth, manufacturer and condition are recorded for all four tires and a spare associated with the current inspection request. Optional equipment listed for the current inspection is verified 7500 by checking the associated pictures. Each item of damage listed is associated with a corresponding picture 7600. The Inspection request status is then stored as COMPLETED 7700 in the Inspection Tracking and Management System data store.

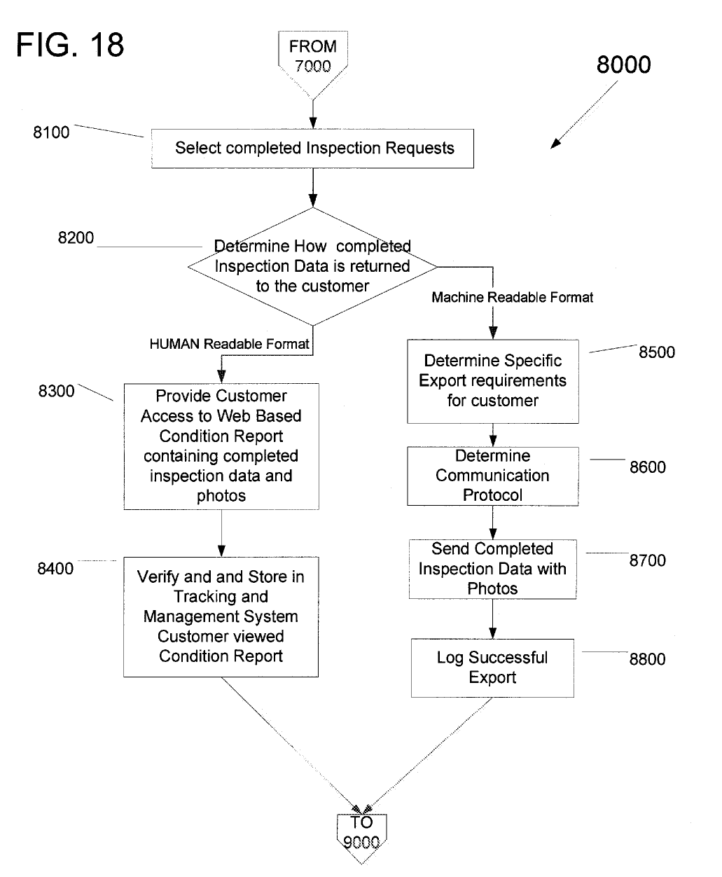

FIG. 18 is a flow chart of the Send to Customer/Owner function of the present invention. The Inspection Tracking and Management System selects completed requests 8100 and determines how the data is returned to the customer 8200. Data may be returned in human readable format or machine readable format.

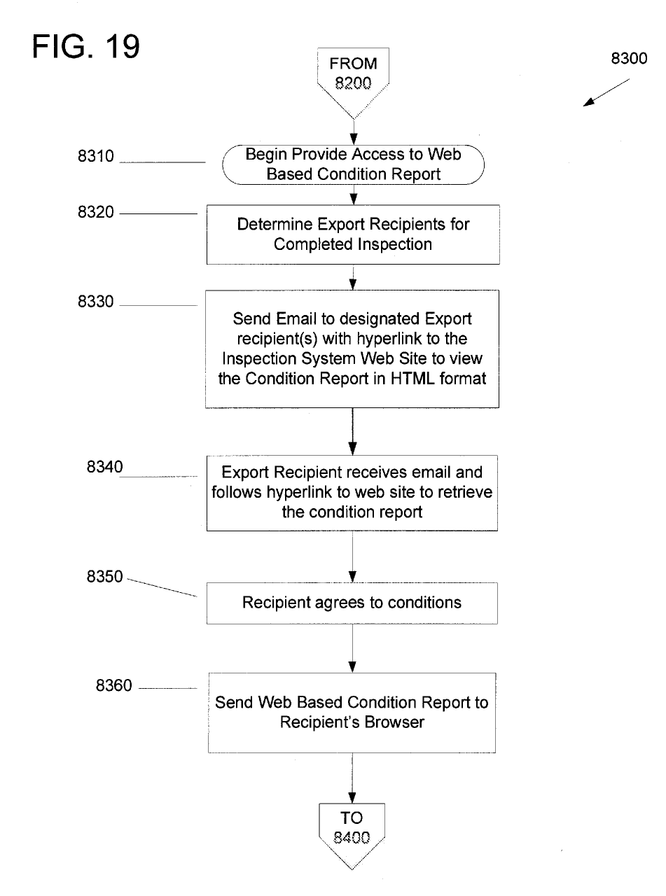

FIG. 19 is a flow chart of the process of providing Access to a Web Based Condition Report of the present invention. The Inspection tracking and Management determines Export Recipients for completed inspection 8320. The next step 8330 is to send an email to the designated Export recipient(s) with a hyperlink to the Inspection System Web Site to view the Condition Report in HTML format. The Export recipient then receives the email and follows the hyperlink to access the Condition Report 8340. The export Recipient is presented with a terms, conditions, and disclaimers which must be agreed to 8350. The Condition Report is then sent to the Export Recipient's web browser 8360 with targeted advertising material based on the information contained in the Condition Report and/or the inspection Request.

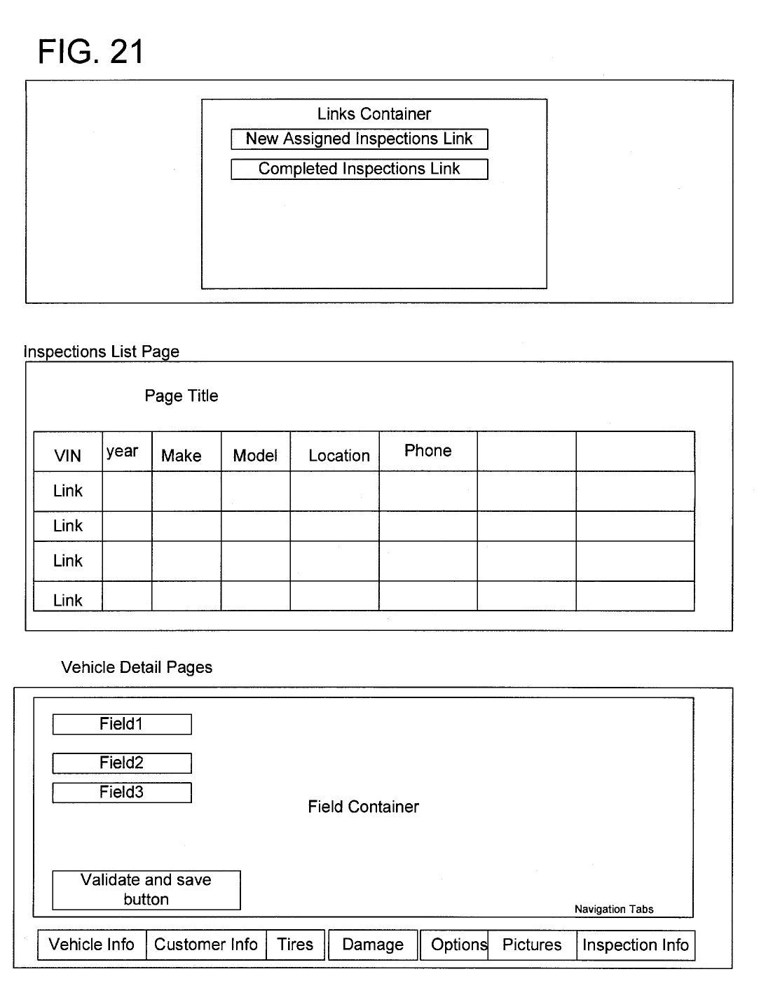

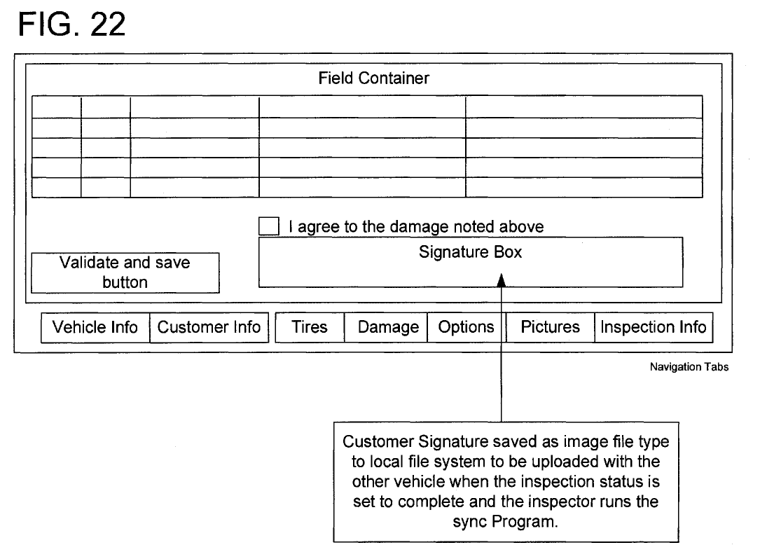

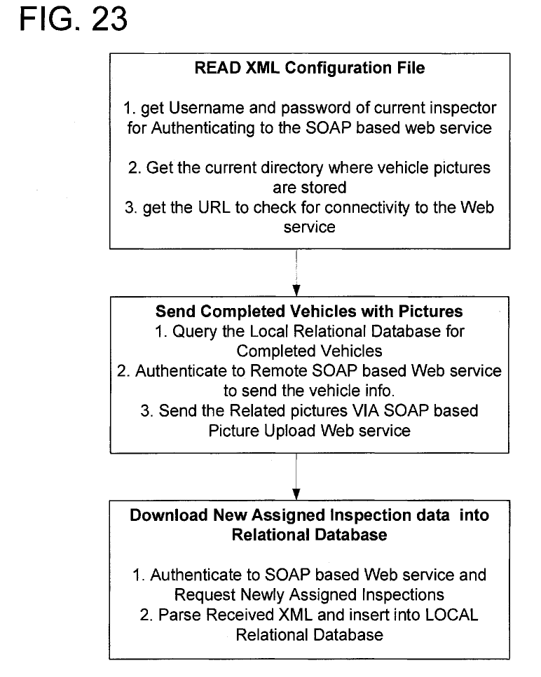

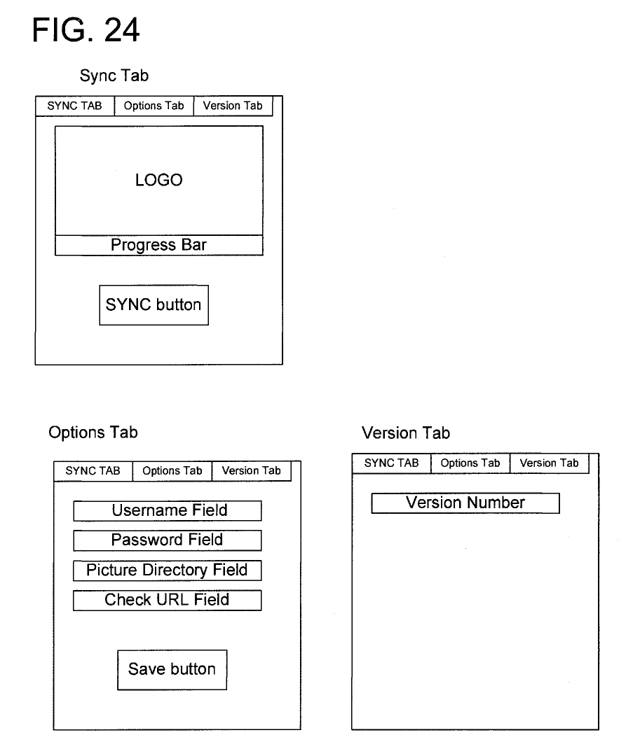

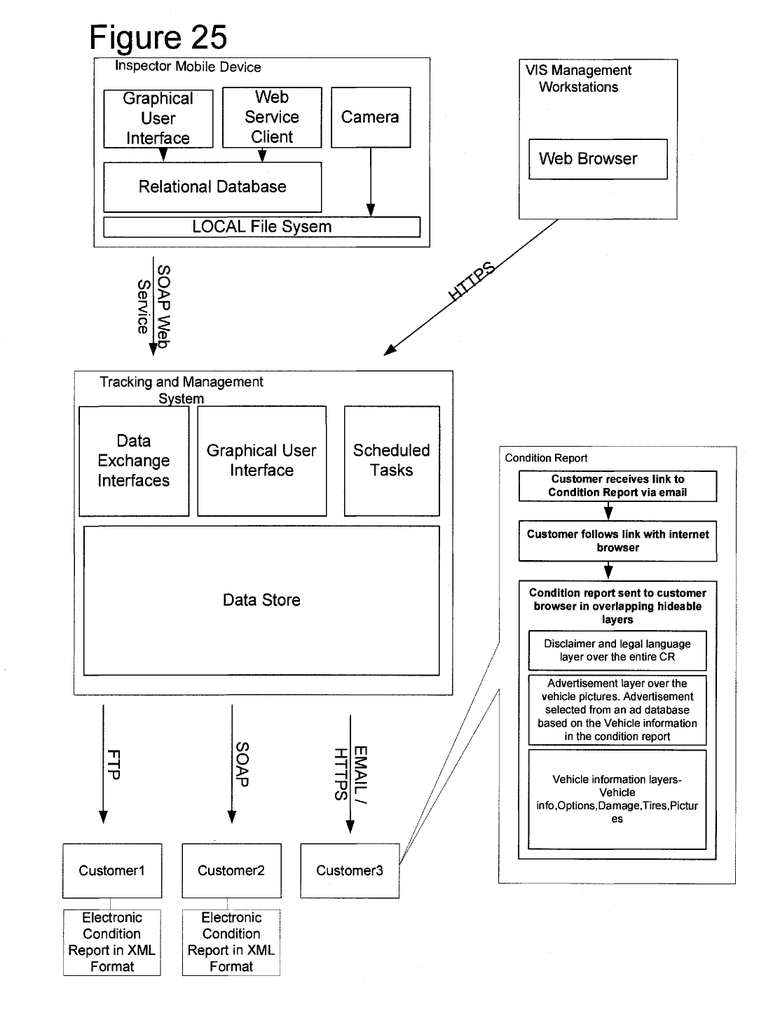

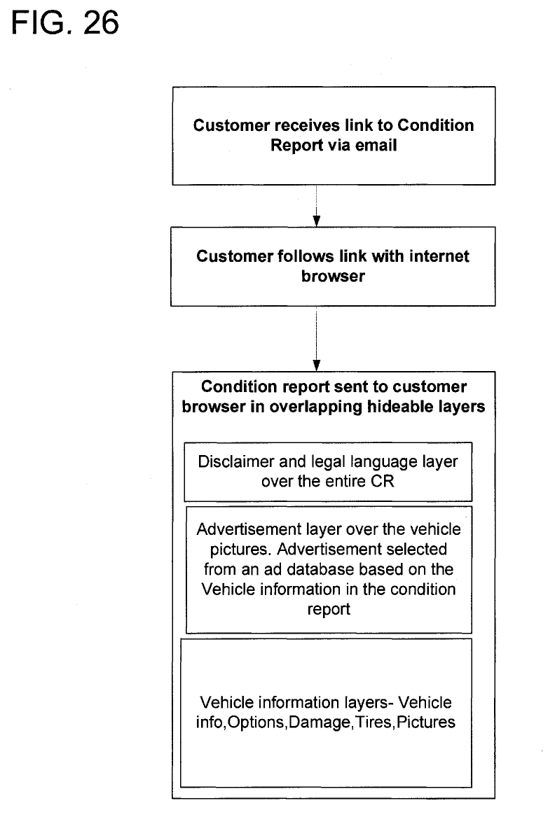

FIG. 20 is a schematic representation of one of the inspection reports. FIG. 21 is a schematic representation of a graphical user interface of the present invention for collecting data. FIG. 22 is schematic representation of a signature capture graphical user interface of the present invention. FIG. 23 is a schematic representation of steps of a synchronization process of the vehicle inspection process of FIG. 2 at the tracking and management system. FIG. 24 is a schematic representation of an inspection mobile device data synchronization graphical user interface. FIG. 25 is another schematic representation of the vehicle inspection system of FIG. 1, showing the vehicle inspection system in more detail. FIG. 26 is a schematic representation of steps of process for an inspection report showing an advertisement that may be based upon demographic information presented to the customer and/or property owner.

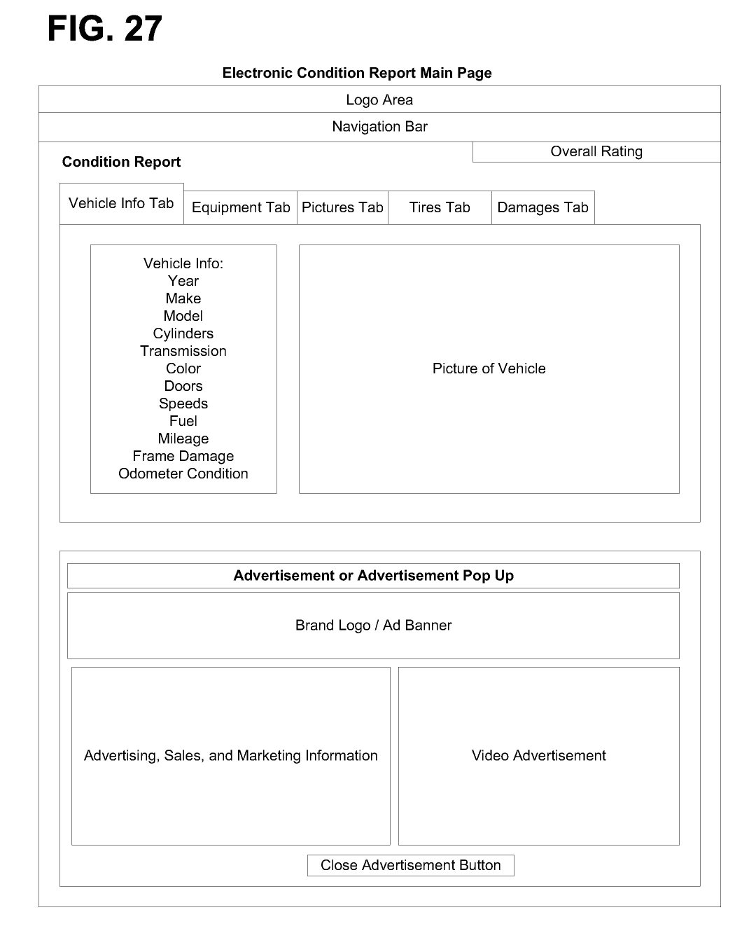

FIG. 27 is a schematic representation of a graphical user interface of a condition report main page of the vehicle inspection system, showing a vehicle condition report and the advertisement, which may be incorporated into the condition report main page and/or shown as a pop up advertisement. The advertisement and/or advertisements may include video, audio, and/or text components and be directed to demographics associated with the requestors and/or the owners of the items and/or property being inspected, and may be targeted to different audiences based upon customer, property owner, and/or requesting entity information. The advertisement and/or advertisements may be nationally and/or regionally directed.

A vehicle inspection system and process of the present invention executing on a hardware device comprising an inspection tracking and management system having features of the present invention comprises, comprises: (a) receiving, at the inspection tracking and management system, a first request electronically from a requesting entity for an inspector to perform an inspection of a vehicle at a remote location, the first request comprising information identifying the vehicle, the remote location, and vehicle owner; (b) selecting, by the inspection tracking and management system, the inspector from a plurality of available inspectors; (c) sending, by the inspection tracking and management system, a second request electronically to the selected inspector for the selected inspector to perform the inspection of the vehicle at the remote location; (d) receiving, by the inspection tracking and management system, an inspection report electronically from the selected inspector comprising information about the condition of the vehicle; (e) processing, by the inspection tracking and management system, the inspection report into a condition report, comprising the information about the condition of the vehicle; (f) sending, by the inspection tracking and management system, to the vehicle owner and the requesting entity, information for accessing the condition report within the inspection tracking and management system; (g) receiving, at the inspection tracking and management system, from the vehicle owner and/or the requesting entity, a third request for accessing the condition report within the inspection tracking and management system; (h) allowing, by the inspection tracking and management system, by the vehicle owner and/or the requesting entity, access to the condition report within the inspection tracking and management system for the vehicle owner and/or the requesting entity to review the condition report.

Although the present invention has been described in considerable detail with reference to certain preferred versions thereof, other versions are possible. Therefore, the spirit and scope of the appended claims should not be limited to the description of the preferred versions contained herein.

What is claimed is:

1. A vehicle inspection process executing on a hardware device comprising an inspection tracking and management system, comprising:
(a) receiving, at the inspection tracking and management system, a first request electronically from a requesting entity for an inspector to perform an inspection of a vehicle at a remote location, the first request comprising information identifying the vehicle, the remote location, and vehicle owner;
(b) selecting, by the inspection tracking and management system, the inspector from a plurality of available inspectors;
(c) sending, by the inspection tracking and management system, a second request electronically to the selected inspector for the selected inspector to perform the inspection of the vehicle at the remote location;
(d) receiving, by the inspection tracking and management system, an inspection report electronically from the selected inspector comprising information about the condition of the vehicle;
(e) processing, by the inspection tracking and management system, the inspection report into a condition report, comprising the information about the condition of the vehicle;
(f) sending, by the inspection tracking and management system, to the vehicle owner and the requesting entity, information for accessing the condition report within the inspection tracking and management system;
(g) receiving, at the inspection tracking and management system, from the vehicle owner and/or the requesting entity, a third request for accessing the condition report within the inspection tracking and management system;
(h) allowing, by the inspection tracking and management system, by the vehicle owner and/or the requesting entity, access to the condition report within the inspection tracking and management system for the vehicle owner and/or the requesting entity to review the condition report.

2. The vehicle inspection process according to claim 1, wherein step (e) further comprises:
incorporating, by the inspection tracking and management system, into the condition report at least one advertisement.

3. The vehicle inspection process according to claim 2, wherein the incorporating, by the inspection tracking and management system, into the condition report the at least one advertisement comprises:
incorporating, by the inspection tracking and management system, into the condition report at least one targeted advertisement.

4. The vehicle inspection process according to claim 1, wherein step (e) further comprises:
incorporating, by the inspection tracking and management system, into the condition report at least one advertisement based upon demographic information of the vehicle owner and/or the requesting entity.

5. The vehicle inspection process according to claim 4, wherein the at least one advertisement comprises at least one regional advertisement.

6. The vehicle inspection process according to claim 2, wherein the at least one advertisement is selected from the group consisting of video, audio, text, and any combination thereof.

7. The vehicle inspection process according to claim 4, wherein the at least one advertisement is selected from the group consisting of video, audio, text, and any combination thereof.
